(19) United States
(12) Patent Application Publication
(10) Pub. No.: US 2008/0258888 A1
(43) Pub. Date: Oct. 23, 2008

(54) Driving support method and driving support system

(75) Inventors: Tomoki Kubota, Okazaki-shi (JP); Minoru Takagi, Okazaki-shi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD, Anjo-shi (JP)

(21) Appl. No.: 11/905,210

(22) Filed: Sep. 28, 2007

(30) Foreign Application Priority Data
Oct. 16, 2006 (JP) 2006-281806

(51) Int. Cl. B60Q 1/00

(52) U.S. Cl. 340/436

(57) ABSTRACT

A driving support unit includes an image signal input section which receives image signals for an area around a vehicle from a camera, a sensor I/F section that detects the head position of a driver sitting in the driver's seat of the vehicle, and a control section. The control section judges whether the driver's head has entered into a projection range of light which is projected from a projector onto a pillar, and an image processor which outputs to the projector data designating the detected driver's head position and surrounding area as a non-projection region.

### INCORPORATION BY REFERENCE

The disclosure of Japanese Patent Application No. 2006-281806 filed on Oct. 16, 2006, including the specification, drawings and abstract, is incorporated herein by reference in its entirety.

### BACKGROUND OF THE INVENTION

1. Field of the Invention

The present invention relates to a driving support method and a driving support system.

2. Description of the Related Art

In-vehicle systems with cameras for imaging driver blind spots and showing the captured images have been developed to support safe driving. One such device uses onboard cameras to capture images of blind-spot regions created by the front pillars of the vehicle, and to display the captured images on the interior surfaces of the front pillars, i.e. the pair of pillars to the left and right, that support the windshield and the roof. Viewed by the driver sitting in the driver's seat, the front pillars are located diagonally to the front and block out part of the driver's field of vision. Nevertheless, they are required to have a predetermined width for the sake of safety.

Such a system includes cameras that are installed on the vehicle body, an image processor that processes the picture signals that are output from the cameras, and a projector or the like that projects the images onto the interior surfaces of the front pillars. Thus, the external background is simulated, as if rendered visible through the front pillars, so that at intersections and the like in the road ahead of the vehicle and any obstructions ahead of the vehicle can be seen.

Japanese Patent Application Publication No. JP-A-11-115546 discloses a system wherein a projector is provided on the instrument panel in the vehicle interior, and mirrors that reflect the projected light are interposed between the projector and the pillars. In such a case, the angles of the mirrors must be adjusted so that the displayed images conform to the shape of the pillars.

However, it is difficult to adjust the mirrors so that the light is projected in the correct directions relative to the pillars. Further, if the mirrors deviate from their proper angles, it is hard to return them to those correct angles.

### SUMMARY OF THE INVENTION

The present invention addresses the foregoing problems, and has, as its objective, provision of a driving support method and a driving support system in which projection of images onto pillars is implemented according to the driver's position. The system of the present invention includes a projector on the inside of the roof at the rear of the vehicle interior or in some like location and copes with the potential problems posed by the driver's head entering the area between the projector and the pillars and that posed by the driver looking directly toward the projector.

According to a first aspect of the present invention, the head position of a driver is sensed, and it is then determined whether the head has entered into a projection range of a projector. If it is determined that the head has entered the projection range, the area surrounding the head position is designated as a non-projection region. Hence, should the driver inadvertently direct his or her gaze toward the projector when his or her head is positioned in proximity to a pillar, the projected light will not directly enter his or her eyes.

According to a second aspect of the present invention, a driving support system senses the head position of the driver, and determines whether or not the head position has entered (overlaps) within the projection range of the projector. If it is determined that the head position is within the projection range, the head position and surrounding area are designated as a non-projection region. Hence, should the driver accidentally direct his or her gaze toward the projector when his or her head is positioned in proximity to a pillar, the projected light will not directly enter his or her eyes.

According to a third aspect of the present invention, only that portion of the projection range entered by the driver's head is designated as a non-projection region, so that even when the head is positioned in proximity to a pillar, the pillar blind-spot region can be displayed while at the same time the projected light is prevented from directly entering the driver's eyes.

According to a fourth aspect of the present invention, when the head position of the driver overlaps any of the various areas of an image display region of the pillar, that overlapped area becomes a non-display region. Hence there is no need for serial computation of the regions overlapped by the head position, and thereby the processing load can be reduced.

According to a fifth aspect of the present invention, when the driver's head enters the projection range, an image is displayed at the base end portion of the pillar, which displayed image is distanced from the head position. Hence, the processing is simplified and the projected light will not directly enter the driver's eyes.

### BRIEF DESCRIPTION OF THE DRAWINGS

FIG. 1 is a block diagram of an embodiment a driving support system in accordance with the present invention;

FIG. 2 is an explanatory diagram of a camera filming range;

FIG. 3 is an explanatory diagram of the positions of a projector and a pillar;

FIG. 4 is a side view of a pillar as seen from the driver's seat;

FIG. 5 is a diagram of a mask pattern;

FIG. 6 is a diagram showing the path of light projected from the projector;

FIG. 7 is a diagram showing the positions of sensors;

FIG. 8 is an explanatory diagram of an image display region divided into four sections;

FIG. 9 is a flowchart of an embodiment of the method of the present invention;

FIG. 10 is an explanatory diagram of a background image with an area surrounding the head not displayed;

FIG. 11 is a table of a variant processing sequence; and

FIG. 12 is a table of another variant processing sequence.

### DESCRIPTION OF THE PREFERRED EMBODIMENTS

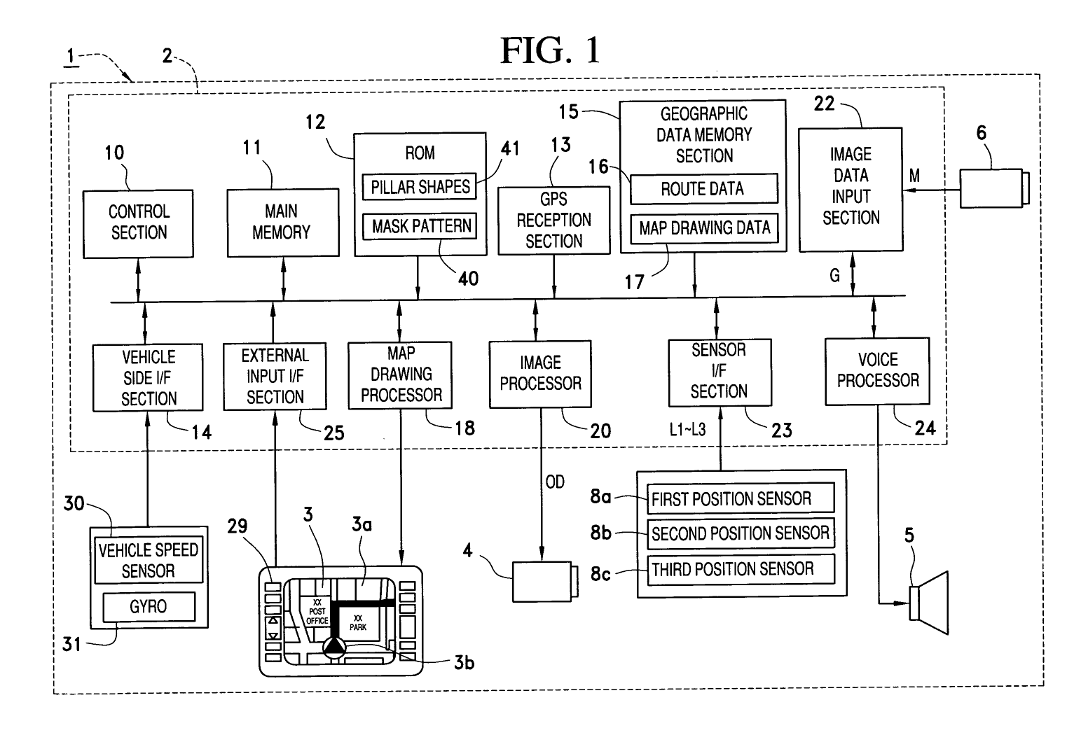

A preferred embodiment of the present invention will now be described with reference to FIGS. 1 to 10.

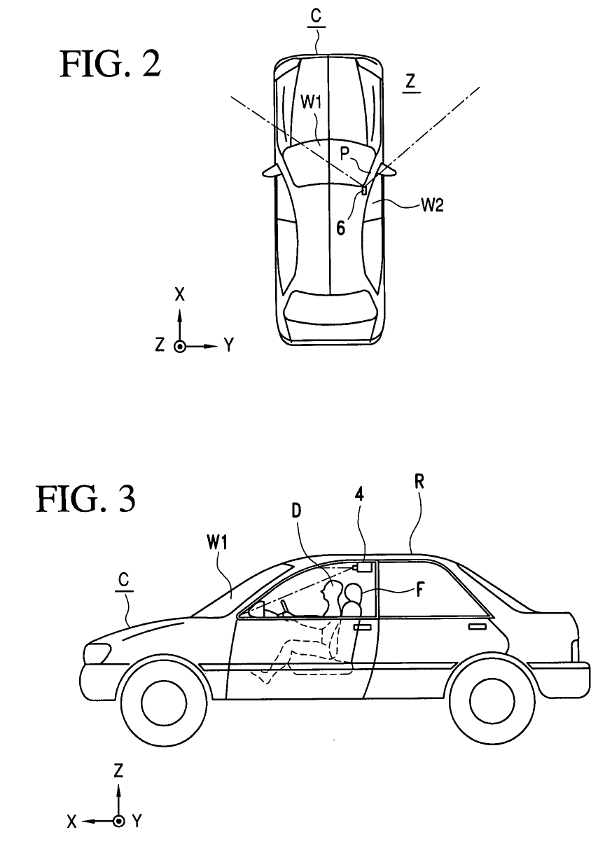

FIG. 1 shows the driving support system 1, installed in a vehicle C (see FIG. 2), as including a driving support unit (or “device”) 2, a display unit 3, a projector 4, a speaker 5, a camera 6, and first to third position sensors 8a to 8c.

The driving support unit 2 includes a control section 10 constituting a detection unit and a judgment unit, a nonvolatile main memory 11, a ROM 12, and a GPS reception section 13. The control section 10 is a CPU, MPU, ASIC or the like, and provides the main control of execution of the various routines of the driving support programs contained in the ROM 12. The main memory 11 temporarily stores the results of computations by the control section 10.

Location signals indicating the latitude, longitude and other coordinates received by the GPS reception section 13 from GPS satellites are input to the control section 10, which computes the absolute location of the vehicle by means of radio navigation. Also input to the control section 10, via a vehicle side I/F section 14 of the driving support unit 2, are vehicle speed pulses and angular velocities from a vehicle speed sensor 30 and a gyro 31, respectively, both mounted in the vehicle C. By means of autonomous navigation using the vehicle speed pulses and the angular velocities, the control section 10 computes the relative location from a reference location and pinpoints the vehicle location by combining the relative location with the absolute location computed using radio navigation.

The driving support unit 2 also includes a geographic data memory section 15. The geographic data memory section 15 is an external storage device such as a built-in hard drive, optical disc or the like. In the geographic data memory section 15 are stored various items of route network data (“route data 16” below) serving as map data used in searching for routes to the destination, and map drawing data 17 for outputting map screens 3a on the display unit 3.

The route data 16 relating to roads is divided in accordance with a grid dividing the whole country into sections. The route data 16 include identifiers for each grid section, node data relating to nodes indicating intersections and road endpoints, identifiers for the links connecting the nodes, and data on link cost and so forth. Using the route data 16, the control section 10 searches for a route to the destination and judges whether or not the vehicle C is approaching a guidance point in the form of an intersection or the like.

The map drawing data 17 is used to depict road forms, backgrounds and the like, and is stored in accordance with the individual grid sections into which the map of the whole country is divided. On the basis of the road form data, included within the map drawing data 17, the control section 10 judges whether or not there are curves of a predetermined curvature or greater ahead of the vehicle C.

As FIG. 1 shows, the driving support unit 2 includes a map drawing processor 18. The map drawing processor 18 reads out, from the geographic data memory section 15, the map drawing data 17 for drawing maps of the vicinity of the vehicle location, then generates data for map output (map output data) and temporarily stores that generated map output data in a VRAM (not shown in the drawings). The map drawing processor 18 outputs to the display unit 3 image signals that are based on the map output data, so that a map screen 3a such as shown in FIG. 1 is displayed. Also, the map drawing processor 18 superimposes on the map screen 3a a vehicle location marker 3b that indicates the vehicle location.

The driving support unit 2 further includes a voice processor 24. The voice processor 24 has voice files (not shown in the drawings), and outputs through the speaker 5 voice that, for example, gives audio guidance along the route to the destination. Moreover, the driving support unit 2 has an external input I/F section 25. Input signals that are based on user input, for example, via operating switches 26 adjoining the display 3, and/or via the touch panel display 3, are input to the external input I/F section 25, which then outputs such signals to the control section 10.

The driving support unit 2 also has an image data input section 22 that serves as an image signal acquisition unit, and an image processor 20 that serves as an output control unit and an image processing unit which receive image data G from the picture data input section 22. The camera 6 provided in the vehicle C is operated under control of the control section 10. Image signals M from the camera 6 are input to the image data input section 22.

The camera 6 is a camera that takes color images, and includes an optical mechanism made up of lenses, mirrors and so forth, and a CCD imaging element. As FIG. 2 shows, the camera 6 is installed on the outside of the bottom end of a right-side front pillar P (below, simply “pillar P”) of the vehicle C, with the optical axis oriented toward the right side of the area ahead of the vehicle C. In the present embodiment the driver's seat is located in the right side of the vehicle C, and therefore the camera 6 is located on the driver's side. The camera 6 images a lateral zone Z that includes the right side of the area ahead of the vehicle C and part of the area on the right side of the vehicle C.

The image signals M output from the camera 6 are digitized by the image data input section 22 and thereby converted into image data G which is output to the image processor 20. The image processor 20 performs image processing on the image data G and outputs the processed image data G to the projector 4.

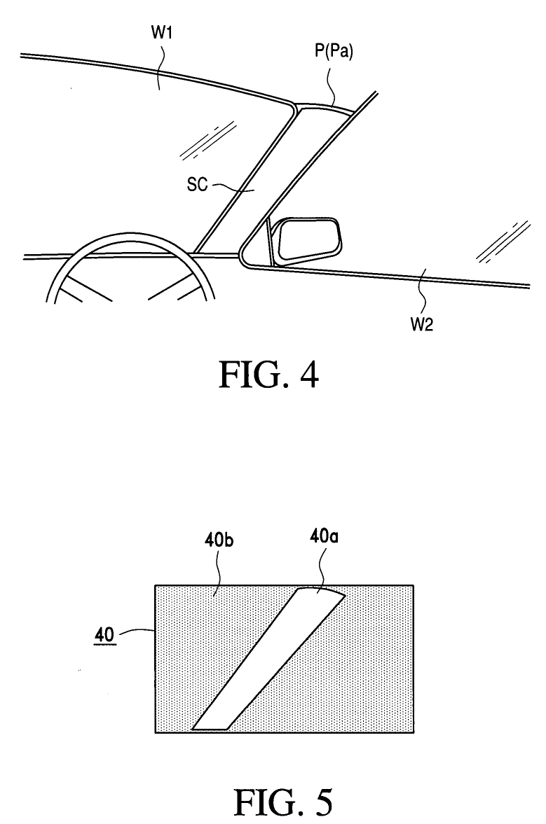

As FIG. 3 shows, the projector 4 is on the inside of the roof R, installed in a position nearly vertically above a front seat F that seats a driver D, from where images can be projected onto the interior surface of the right-side pillar P of the vehicle C (see FIG. 4). As FIG. 4 shows, a screen SC, that is cut to match the shape of the pillar P, is provided on the interior surface Pa of the pillar P. The focal point of the projector 4 is adjusted to coincide with this screen SC. Note that where the interior surface Pa of the pillar P is of a material and a shape enabling it to receive the projected light from the projector 4 and to display such as clear images, the screen SC may be omitted.

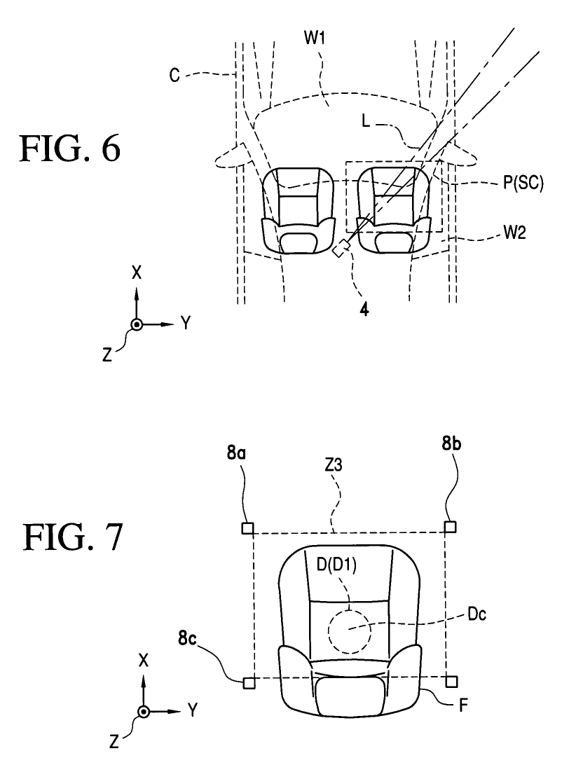

Also, a mask pattern 40 with pillar shapes 41 is prestored in the ROM 12 of the driving support unit 2 during the manufacturing process, as shown in FIG. 1. The mask pattern 40, as shown in FIG. 5, is data for applying a mask to the image data G. The mask pattern 40 includes an image display region 40a that constitutes the projection range and conforms to the shape of the interior surface of the pillar P, and a mask region 40b. The image processor 20 generates output data OD that, for the image display region 40a zone, consists of a portion of the image data G originating from the camera 6, and that, for the mask 40b zones, is for non-display. The output data OD, generated by the image processor 20, is sent to the projector 4. Subsequently, as shown in FIG. 6, projected light L is output from the projector 4 onto the screen SC on the pillar P, whereby images are displayed on the screen SC. At the same time, the mask 40b prevents images from being projected onto the windshield W1 or onto the door window W2 that flank the screen SC.

The pillar shapes 41 are formed by data representing the contours of the pillar, as a pattern or as coordinates, and thus vary depending on the vehicle C. On the basis of the pillar shapes 41, the control section 10 is able to acquire coordinates representing the contours of the pillar P.

The driving support unit 2 further includes, as shown by FIG. 1, a sensor I/F section 23 constituting a sensing unit. Sensing signals from the first to third position sensors 8a to 8c are input into the sensor I/F section 23. The first to third position sensors 8a to 8c are ultrasound sensors, and as FIG. 7 shows, are located in the vehicle interior in the area around the driver's seat F. The first position sensor 8a is installed in proximity to the rearview mirror (omitted from the drawings), which is located at almost the same height as the driver's head D1 or at a slightly higher position.

The second position sensor 8b is installed close to the top edge of the door window W2, so as to be located to the right and diagonally to the front of the driver D. The third position sensor 8c is on the left side of the front seat F, on the interior of the roof R. The ultrasound waves emitted from the sensor heads of the position sensors 8a to 8c are reflected by the driver's head D1. The position sensors 8a to 8c determine the time between emission of the ultrasound waves and reception of the reflected waves, and on the basis of the determined time, each calculates one of the respective relative distances L1 to L3 to the driver's head D1. The calculated relative distances L1 to L3 are output to the control section 10 via the sensor I/F section 23. Alternatively the sensor I/F section 23 could compute the relative distances L1 to L3 to the driver's head D1 on the basis of the signals from the position sensors 8a to 8c.

When the driver's seat is occupied, the control section 10 acquires, using triangulation or other conventional method, a head motion range Z3, through which the driver's head D1 of standard body type can move, and also, according to the relative distances L1 to L3 sensed by the first to third position sensors 8a to 8c, a center coordinate Dc of the head D1.

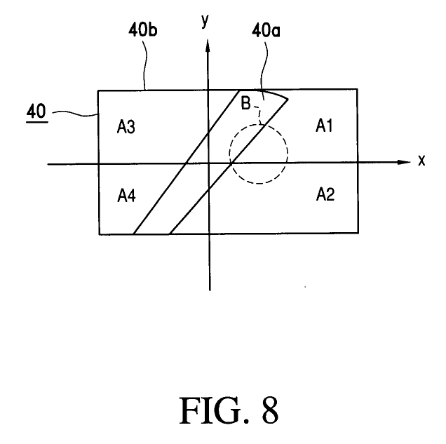

Next, the control section 10 judges whether the head D1 has entered into the projection range of the projector 4. Using the center coordinates Dc (see FIG. 7) computed for the driver's head D1, the control section 10 computes the coordinates of a sphere B that models the head and has the center coordinate Dc as its center, as shown in FIG. 8, then judges whether that sphere B overlaps the image display region 40a of the pillar P. As shown in FIG. 8, if it is judged that the sphere B does overlap the image display region 40a, the control section 10 then judges which of the four areas A1 to A4, into which the image display region 40a is divided, is overlapped. In the case where the sphere B overlaps with the first area A1 and the second area A2 of the image display region 40a as shown in FIG. 8, the control section 10 controls the image processor 20 to generate image signals that designate the first area A1 and the second area A2 as non-display regions. As a result, those regions of the screen SC on the pillar P that correspond to the first area A1 and the second area A2 will not have images displayed thereon. This means that, even if the driver inadvertently looks in the direction of the projector 4, the projected light L will not directly enter his or her eyes, since the projected light L from the projector 4 is not output in the proximity of the head D1.

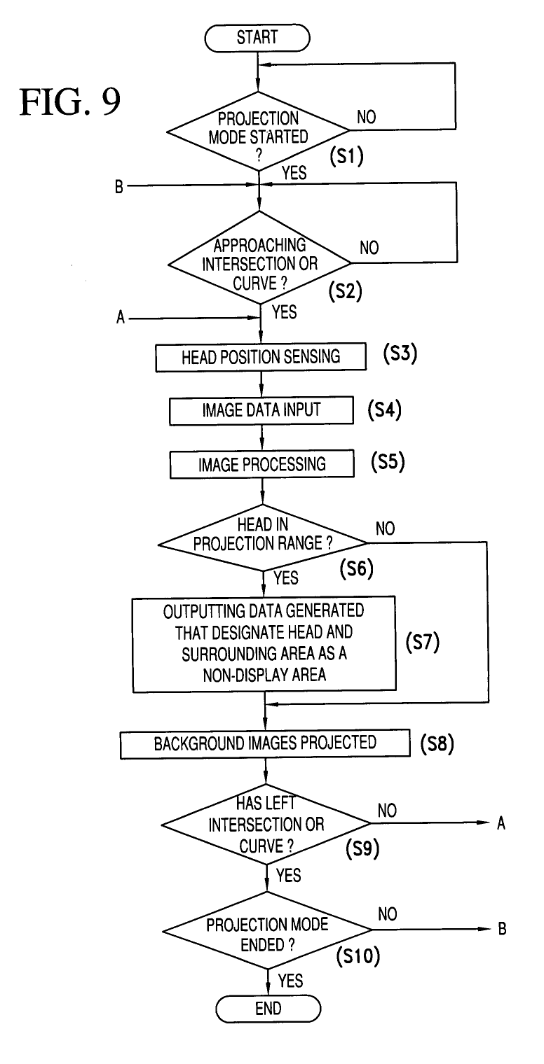

The method of the present embodiment will now be described with reference to FIG. 9. In step S1, the control section 10 of the driving support unit 2 waits for the start of the projection mode, in which background images are projected onto the interior surface of the pillar P. The projection mode will, for example, be judged to start when, as a result of operation of the touch panel or operation switches 26, the control section 10 receives a mode start request via the external input I/F section 25. Or, if the projection mode is automatically started, the projection mode can be judged to start based on the ON signal from the ignition module.

Once the projection mode is judged to have started (YES in step S1), in step S2 the control section 10 judges, according to the route data 16 or the map drawing data 17, whether or not the vehicle is approaching an intersection or a curve. Specifically, the control section 10 judges that the vehicle C is approaching an intersection or curve if it determines that the present location of the vehicle C is within a predetermined distance (say 200 m) from an intersection, including a T-junction, or from a curve of a predetermined curvature or greater.

Once the vehicle is judged to be approaching an intersection or a curve (YES in step S2), in step S3 the control section 10 senses the head position of the driver D, using the position sensors 8a to 8c. To do so, the control section 10 acquires from the position sensors 8a to 8c, via the sensor I/F section 23, the relative distances L1 to L3 to the head D1, then pinpoints the center coordinate Dc of the head D1 on the basis of the relative distances L1 to L3.

Once the head position has been computed, in step S4 the image data G is input to the image processor 20 from the picture data input section 22, and then in step S5 image processing is executed in accordance with the center coordinate Dc of the head D1. More precisely, by conventional image processing, such as coordinate transformation, in accordance with the center coordinate Dc, the images are made to more closely resemble the actual background. At this point the image processor 20 reads the mask pattern 40 out from the ROM 12, reading pixel values for the image data G for the image display region 40a of the mask pattern 40, and non-display pixel values for the projector 4 for the other regions, then generates the output data OD.

Further, in step S6, the control section 10 judges whether the driver's head D1 is in the projection range of the projector 4. As described earlier, the control section 10 computes the coordinates of the sphere B modeling the head D1 and having as its center the center coordinate Dc of the head D1, then judges whether the sphere B overlaps the image display region 40a of the pillar P. If such overlap is judged, the head D1 is judged to be in the projection range of the projector 4 (YES in step S6), and by designating as non-display those of the areas A1 to A4 which overlap the sphere B, generates output data OD that render the head D1 and its surrounding area non-displayed (step S7).

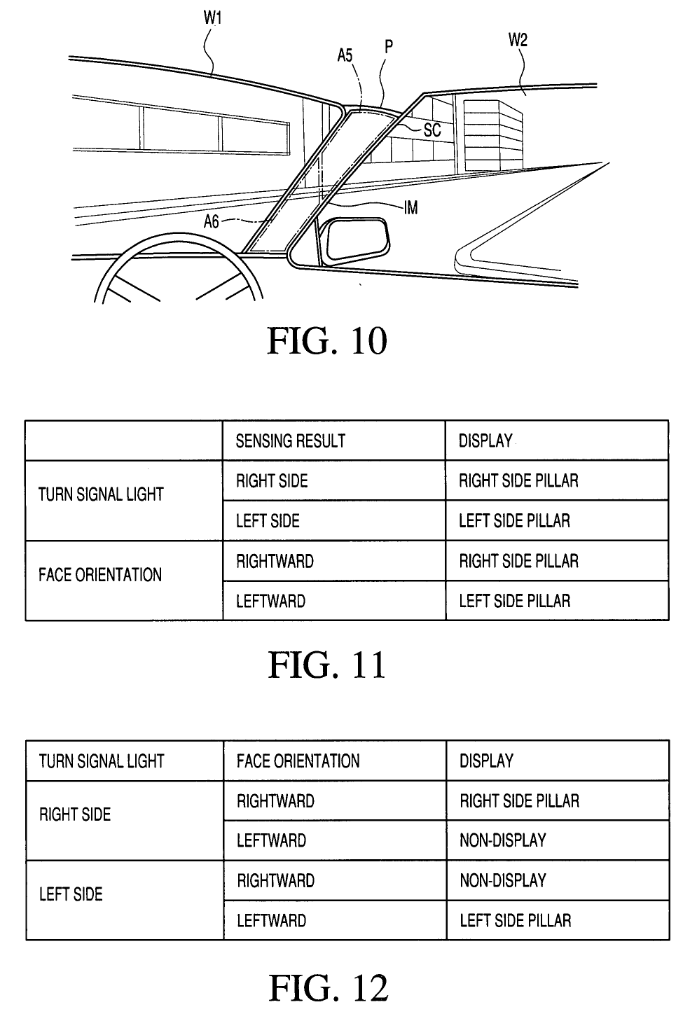

Once the output data OD has been generated, in step S8 the image processor 20 sends the data OD to the projector 4, and the projector 4 performs D/A conversion of the data OD and projects the background images onto the screen SC on the pillar P. As a result, the background images IM are displayed on the screen SC, as shown in FIG. 10. The background images IM shown in FIG. 10 are those that are displayed in the case where the head D1 of the driver has entered into the projection range, with no image displayed (projected) in a non-projection area A5 with which the head D1 overlaps, and with the images of the blind-spot region due to the pillar P displayed in the remainder of the projection area A6. In the case of the background images IM shown in FIG. 10, the non-projection area A5 corresponds to the first and second areas A1, A2 and the projection area A6 corresponds to the third and fourth areas A3, A4. Consequently, should the driver inadvertently look toward the projector 4 when the head D1 is in the area around the pillar P, the projected light L will not directly enter his or her eyes.

Once the background images IM are displayed on the screen SC, in step S9 the control section 10 judges whether or not the vehicle C has left the intersection or the curve. If it is judged that the vehicle C is approaching or has entered the intersection or the curve (NO in step S9), then the sequence returns to step S3 and the control section 10 receives signals from the position sensors 8a to 8c and computes the center coordinate Dc of the head D1.

Once the vehicle C is judged to have left the intersection or the curve (YES in step S9), in step S10 the control section 10 judges whether or not the projection mode has ended. The control section 10 will, for example, judge the projection mode to have ended (YES in step S10) upon operation of the touch panel or the operating switches 26, or upon input of an ignition module OFF signal, and will then terminate processing. If it is judged that the projection mode has not ended (NO in step S10), the routine returns to step S2 and remains on standby until the vehicle C approaches an intersection or curve. When the vehicle C approaches an intersection or curve (YES in step S2), the above-described routine will be repeated.

The foregoing embodiment yields the following advantages.

(1) With the foregoing embodiment, the control section 10 of the driving support unit 2 computes the center coordinate Dc of the head D1 of the driver D according to input from the first to third position sensors 8a to 8c, and also, on the basis of the center coordinates Dc, judges whether the driver's head D1 overlaps any of the areas A1 to A4 of the image display region 40a, and designates any such overlapping areas as non-display regions. Hence, when the head position of the driver D is close to the pillar P, the head position and surrounding area will not be displayed and, therefore, it becomes possible to display the background image IM of the pillar P blind-spot region, and at the same time to prevent the projected light L from directly entering the driver's eyes should he or she inadvertently look toward the projector 4.

(2) With the foregoing embodiment, because the image display region 40a is divided into four areas A1 to A4 and a judgment is made as to whether or not the head position overlaps any of the areas A1 to A4, there is no need for serial computation of the overlapping regions. Hence, the processing load on the driving support unit 2 is reduced.

Numerous variants of the foregoing embodiment are possible, as described below.

The position sensors 8a to 8c, which in the foregoing embodiment are provided on the interior side of the roof R, in proximity to the rearview mirror and close to the upper edge of the door window W2, can be located in other positions. Also, whereas the foregoing embodiment has three sensors for sensing the position of the head D1, there could, in the alternative, be two, or four or more. Further, although the position sensors 8a to 8c are ultrasound sensors, alternatively, they could be infrared ray sensors or other sensors.

While in the foregoing embodiment the driver's head D1 is sensed by means of the position sensors 8a to 8c, which are ultrasound sensors, alternatively the driver's head could be sensed by means of a camera in proximity to the driver's seat to capture an image of the driver's seat and the surrounding area, and the captured image subjected to image processing such as feature-point detection, pattern matching or the like.

In the foregoing embodiment the image data input section 22 generates the image data G but, instead, the image data G could be generated in the cameras 6 by A/D conversion.

In the foregoing embodiment the background images IM are displayed on the driver's seat side pillar P (the right side front pillar in the embodiment), but the background images can also be displayed on the pillar on the side opposite the driver's seat. In that case, the coordinates of the head D1, and the angles of the blind spots blocked out by the pillars are computed, and the cameras switched according to such angles.

It would be possible in the foregoing embodiment, at the times when it is judged that the driver's head D1 has entered the projection range, to disregard any regions of overlap and to display the images on only the base end portion of the pillar P, corresponding to the third and fourth areas A3, A4 (see FIG. 8), which is distanced from the head position of the driver D. This modification would simplify processing, and it would still be possible to prevent the projected light L from directly entering the driver's eyes.

In the foregoing embodiment, the head D1 and surrounding area are not displayed when the projection range and the head position overlap but, alternatively, the projector could be controlled so as not to output projected light at such times.

The foregoing embodiment could also be configured so that the images are displayed on whichever of the right side and left side pillars P is on the same side as that to which the face of the driver D is oriented or for which a turn signal light is operated. The orientation of the face of the driver D would be sensed via image processing of the image data G For example, as in table 50 shown in FIG. 11, when the right side turn signal light from the viewpoint of the driver D is operating, the images are displayed on the right side pillar P, and when the left side turn signal light is operating, the images are displayed on the left side pillar P. Also, when the face of the driver D is oriented rightward, the images would be displayed on the right side pillar P, and when it is oriented leftward, the images would be displayed on the left side pillar P. Further, in those cases where the side for which a turn signal light is operated coincides with the orientation of the face, the images could be displayed on the pillar on that side, as in table 51 shown in FIG. 12. For example, when the operating turn signal light and the orientation of the face are both on/toward the right side, images would be displayed on the right side pillar P, whereas when the operating turn signal light is on the right side but the face is oriented leftward, the images would not be displayed. After selection of the pillar P for display of the images, the head position of the driver D would be sensed and a judgment would be made as to whether or not the head position overlaps the image display region 40a of the pillar P. In this way it would be possible to output only the minimum necessary projected light onto the pillars P, thus preventing direct entry of the projected light L into the driver D's eyes.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A method for supporting driving by using a camera installed in a vehicle to capture an image of a blind-spot region created by a pillar of the vehicle and a projector for projecting the image captured by the camera onto the interior surface of the pillar, the method comprising:
sensing head position of a driver sitting in a driver's seat;
judging whether the driver's head has entered into a projection range in which light is projected from the projector onto the pillar; and
designating the head position and surrounding area as a non-projection region within the projection range, through which no light is projected, responsive to a judgment that the driver's head has entered into the projection range.

2. The method of claim 2 wherein the projection range is divided into projection and non-projection regions and further comprising:
projecting an image, corresponding to the blind-spot region created by the pillar, onto the interior surface of the pillar, through the projection region.

3. A driving support system comprising:
a camera installed in a vehicle to capture an image of an area around the vehicle including a blind-spot region created by a pillar of the vehicle;
a projector which projects an image of the blind spot region onto an interior surface of the pillar,
an image signal acquisition unit which receives image signals from the camera;
a sensing unit that senses head position of a driver sitting in a driver's seat of the vehicle;
a judgment unit that judges whether the driver's head has entered into a projection range in which light is projected from the projector onto the pillar; and
an output control unit that designates at least an area surrounding the sensed head position as a non-projection region, through which no light is projected, responsive to a judgment that the driver's head has entered into the projection range.

4. The driving support system according to claim 3, wherein the output control unit outputs to the projector signals that designate a region of the projection range into which the driver's head has entered as the non-projection region, and a remainder of the projection range as a projection region in which an image corresponding to the blind-spot region created by the pillar is projected.

5. The driving support system according to claim 3, wherein the output control unit identifies any of multiple areas, into which an image display region of the pillar is divided, overlapped by the head position of the driver, and designates any such overlapped areas as a non-projection region.

6. The driving support system according to claim 3, wherein when the driver's head has entered into the projection range, the projected light is projected only onto a base end portion of the pillar, which base end portion is distanced from the head position.

7. The driving support system according to claim 4, wherein the output control unit identifies any of multiple areas, into which an image display region of the pillar is divided, overlapped by the head position of the driver, and designates any such overlapped areas as a non-projection region.
